(19) United States
(12) Patent Application Publication
(10) Pub. No.: US 2023/0272207 A1
(43) Pub. Date: Aug. 31, 2023

(54) Thermoplastic Resin Composition and Molded Article Produced Therefrom

(71) Applicant: LOTTE CHEMICAL CORPORATION, Seoul (KR)

(72) Inventors: Sanghyun HONG, Uiwang-si (KR); Hanna KIM, Uiwang-si (KR); Bongjun SONG, Uiwang-si (KR); Youngsub JIN, Uiwang-si (KR); Wonyoung CHOI, Uiwang-si (KR)

(21) Appl. No.: 17/802,232

(22) PCT Filed: Feb. 22, 2021
(86) PCT No.: PCT/KR2021/002185

§ 371 Date: Aug. 25, 2022

(30) Foreign Application Priority Data
Feb. 28, 2020 (KR) 10-2020-0025547

(51) Int. Cl. C08L 55/02; C08L 25/12; C08F 222/06; C08G 69/14; C08G 69/44; C08G 65/08

(52) U.S. Cl. CPC C08L 55/02; C08F 222/06; C08G 65/08; C08G 69/14; C08G 69/44; C08L 25/12; C08L 2205/025; C08L 2205/035; C08L 2207/53

(57) ABSTRACT

The present invention relates to a thermoplastic resin composition and a molded article produced therefrom, the thermoplastic resin composition including, based on 100 parts by weight of a base resin including (A1) 20 to 40 wt% of a butadiene-based rubber-modified aromatic vinyl-vinyl cyanide graft copolymer, (A2) 30 to 75 wt% of an aromatic vinyl-vinyl cyanide copolymer, and (B) 5 to 40 wt% of a polyamide resin, (C) 1 to 15 parts by weight of a polyether ester amide block copolymer, and (D) 0.5 to 10 parts by weight of a maleic anhydride-aromatic vinyl-vinyl cyanide copolymer.

### TECHNICAL FIELD

A thermoplastic resin composition and a molded article produced therefrom are disclosed.

### BACKGROUND ART

Styrene-based resins, represented by acrylonitrile-butadiene-styrene copolymer (ABS) resins, are widely used in various applications due to their excellent moldability, mechanical properties, appearance, secondary processability, and the like.

A molded article produced by using a styrene-based resin may be widely applied to various products that require painting/non-painting, for example, may be applied to various interior/exterior materials of automobiles and/or electronic devices.

Herein, in order to impart an aesthetic effect to the various interior/exterior materials, the painting may sometimes be conducted for the molded article manufactured by using the styrene-based resin. The painting may be performed in a generally widely used electrostatic painting method without particular limitations. This electrostatic painting method may be a method of applying electrical conductivity to the surface of the molded article and then proceeding with the painting, wherein in order to conduct the painting, the surface of the molded article should be pre-treated with a conductive primer and the like.

Since this application of the conductive primer increases the number of processes and manufacturing time, a method of further including various conductive materials (e.g., carbon nanotubes, etc.) and/or conductivity expression additives in the styrene-based resin to secure the electrical conductivity of the molded article itself at a predetermined level or higher has recently been suggested.

However, when the conductive materials and/or the conductivity expression additives are added to the styrene-based resin, physical properties of the styrene-based resin may be damaged, thereby unexpectedly deteriorating various physical properties.

Accordingly, development of a thermoplastic resin composition maintaining excellent electrical conductivity and balance of physical properties is required.

### DISCLOSURE

### Description of the Drawings

### Technical Problem

A thermoplastic resin composition having excellent electrical conductivity and balance of physical properties, and a molded article prepared therefrom, are provided.

### Technical Solution

According to an embodiment, a thermoplastic resin composition includes, based on 100 parts by weight of a base resin including (A1) 20 to 40 wt% of a butadiene-based rubber-modified aromatic vinyl-vinyl cyanide graft copolymer; (A2) 30 to 75 wt% of an aromatic vinyl-vinyl cyanide copolymer; and (B) 5 to 40 wt% of a polyamide resin, (C) 1 to 15 parts by weight of a polyether ester amide block copolymer; and (D) 0.5 to 10 parts by weight of a maleic anhydride-aromatic vinyl-vinyl cyanide copolymer.

The (A1) butadiene-based rubber-modified aromatic vinyl-vinyl cyanide graft copolymer may have a core-shell structure including a core of a butadiene-based rubbery polymer, and a shell formed by graft polymerization of an aromatic vinyl compound and a vinyl cyanide compound.

In the (A1) butadiene-based rubber-modified aromatic vinyl-vinyl cyanide graft copolymer, an average particle diameter of the butadiene-based rubbery polymer may be 0.2 to 1.0 µm.

The (A1) butadiene-based rubber-modified aromatic vinyl-vinyl cyanide graft copolymer may be an acrylonitrile-butadiene-styrene graft copolymer.

The (A2) aromatic vinyl-vinyl cyanide copolymer may include 55 to 80 wt% of a component derived from an aromatic vinyl compound and 20 to 45 wt% of a component derived from a vinyl cyanide compound, based on 100 wt%.

The (A2) aromatic vinyl-vinyl cyanide copolymer may have a weight average molecular weight of 80,000 to 300,000 g/mol.

The (A2) aromatic vinyl-vinyl cyanide copolymer may be a styrene-acrylonitrile copolymer.

The (B) polyamide resin may include polyamide 6, polyamide 66, polyamide 46, polyamide 11, polyamide 12, polyamide 610, polyamide 612, polyamide 61, polyamide 6T, polyamide 4T, polyamide 410, polyamide 510, polyamide 1010, polyamide 1012, polyamide 10T, polyamide 1212, polyamide 12T, polyamide MXD6, or a combination thereof.

The (C) polyether ester amide block copolymer may be a reaction mixture of an aminocarboxylic acid, lactam, or a diamine-dicarboxylic acid salt having 6 or more carbon atoms; polyalkylene glycol; and a dicarboxylic acid having 4 to 20 carbon atoms.

In the (D) maleic anhydride-aromatic vinyl-vinyl cyanide copolymer, the aromatic vinyl may include styrene, α-methylstyrene, β-methylstyrene, p-methylstyrene, p-t-butylstyrene, ethylstyrene, vinylxylene, mono chlorostyrene, dichlorostyrene, dibromostyrene, or a combination thereof, and the vinyl cyanide may include acrylonitrile, methacrylonitrile, fumaronitrile, or a combination thereof.

The (D) maleic anhydride-aromatic vinyl-vinyl cyanide copolymer may be a maleic anhydride-styrene-acrylonitrile copolymer.

The thermoplastic resin composition may further include at least one additive selected from a nucleating agent, a coupling agent, a filler, a plasticizer, a lubricant, a mold release agent, an antibacterial agent, a heat stabilizer, an antioxidant, an ultraviolet stabilizer, a flame retardant, a colorant, and an impact modifier.

Meanwhile, according to another embodiment, a molded article produced from the aforementioned thermoplastic resin composition is provided.

The molded article may have a notch Izod impact strength of a ¼”thick specimen according to ASTM D256 ranging from 20 to 60 kgf · cm/cm.

The molded article may have surface resistance of less than or equal to 10^{12.0} Ω/sq measured for a 100 mm x 100 mm x 20 mm specimen using a surface resistance measuring device (manufacturer: SIMCO-ION, device name: Worksurface Tester ST-4).

The molded article may have a heat deflection temperature (HDT) of 80 to 100° C. according to ASTM D648.

### Advantageous Effects

The thermoplastic resin composition according to an embodiment and a molded article using the same exhibit excellent electrical conductivity and balance of physical properties, and thus may be widely applied to molding various products used for painting and non-painting, and in particular, may also be usefully applied to molded articles for painting requiring electrostatic painting.

### MODE FOR INVENTION

Hereinafter, embodiments of the present invention are described in detail. However, these embodiments are just examples, and the present disclosure is not limited thereto and the present disclosure is defined by the scope of claims.

In the present invention, unless otherwise specified, the average particle diameter is a volume average diameter, and means a Z-average particle diameter measured using a dynamic light scattering analyzer.

According to an embodiment, a thermoplastic resin composition includes, based on 100 parts by weight of a base resin including (A1) 20 to 40 wt% of a butadiene-based rubber-modified aromatic vinyl-vinyl cyanide graft copolymer; (A2) 30 to 75 wt% of an aromatic vinyl-vinyl cyanide copolymer; and (B) 5 to 40 wt% of a polyamide resin, (C) 1 to 15 parts by weight of a polyether ester amide block copolymer; and (D) 0.5 to 10 parts by weight of a maleic anhydride-aromatic vinyl-vinyl cyanide copolymer.

Hereinafter, each component of the thermoplastic resin composition is described in detail.

### (A1) Butadiene-Based Rubber-Modified Aromatic Vinyl-Vinyl Cyanide Graft Copolymer

In an embodiment, the butadiene-based rubber-modified aromatic vinyl-vinyl cyanide graft copolymer imparts excellent impact resistance to the thermoplastic resin composition. In an embodiment, the butadiene-based rubber-modified aromatic vinyl-vinyl cyanide graft copolymer may have a core-shell structure including a core of a butadiene-based rubbery polymer component and a shell formed on the core by a graft polymerization reaction of an aromatic vinyl compound and a vinyl cyanide compound.

The butadiene-based rubber-modified aromatic vinyl-vinyl cyanide graft copolymer according to an embodiment may be obtained by adding an aromatic vinyl compound and a vinyl cyanide compound to a butadiene-based rubbery polymer, and performing graft polymerization through conventional polymerization methods such as emulsion polymerization and bulk polymerization.

The butadiene-based rubbery polymer may be selected from a butadiene rubbery polymer, a butadiene-styrene rubbery polymer, a butadiene-acrylonitrile rubbery polymer, a butadiene-acrylate rubbery polymer, and a mixture thereof.

The aromatic vinyl compound may be selected from styrene, αmethylstyrene, p—methylstyrene, p-t-butylstyrene, 2,4-dimethylstyrene, chlorostyrene, vinyltoluene, vinylnaphthalene, and a mixture thereof.

The vinyl cyanide compound may be selected from acrylonitrile, methacrylonitrile, fumaronitrile, and a mixture thereof.

In the butadiene-based rubber-modified aromatic vinyl-vinyl cyanide graft copolymer, an average particle diameter of the butadiene-based rubbery polymer may be, for example, 0.2 to 1.0 µm, for example 0.2 to 0.8 µm, or for example 0.25 to 0.40 µm. When the above range is satisfied, the thermoplastic resin composition may exhibit excellent impact resistance and appearance characteristics.

Based on 100 wt% of the butadiene-based rubber-modified aromatic vinyl-vinyl cyanide graft copolymer, the butadiene-based rubbery polymer may be included in an amount of 40 to 70 wt%. On the other hand, a weight ratio of the aromatic vinyl compound and the vinyl cyanide compound which are graft-polymerized on the core of the butadiene-based rubbery polymer component may be 6:4 to 8:2.

In an embodiment, the butadiene-based rubber-modified aromatic vinyl-vinyl cyanide graft copolymer may be an acrylonitrile-butadiene-styrene graft copolymer.

The butadiene-based rubber-modified aromatic vinyl-vinyl cyanide graft copolymer may be included in an amount of 20 to 40 wt%, for example 25 to 40 wt%, or for example 25 to 35 wt%, based on 100 wt% of the base resin.

When an amount of the butadiene-based rubber-modified aromatic vinyl-vinyl cyanide graft copolymer in the base resin is less than 20 wt%, it is difficult to achieve excellent impact resistance, and when it exceeds 40 wt%, heat resistance and fluidity may decrease.

### (A2) Aromatic Vinyl-Vinyl Cyanide Copolymer

In an embodiment, the aromatic vinyl-vinyl cyanide copolymer may improve fluidity of the thermoplastic resin composition and maintain compatibility between components at a certain level.

In an embodiment, the aromatic vinyl-vinyl cyanide copolymer may have a weight average molecular weight of greater than or equal to 80,000 g/mol, for example greater than or equal to 85,000 g/mol, or for example greater than or equal to 90,000 g/mol, and for example less than or equal to 300,000 g/mol, or for example less than or equal to 200,000 g/mol, for example 80,000 to 300,000 g/mol, or for example 80,000 to 200,000 g/mol.

In the present invention, the weight average molecular weight is measured by dissolving a powder sample in tetrahydrofuran (THF), and then using gel permeation chromatography (GPC) 1200 series made by Agilent Technologies (polystyrene is used as a standard sample).

In an embodiment, the aromatic vinyl-vinyl cyanide copolymer may be prepared through conventional polymerization methods such as emulsion polymerization, suspension polymerization, solution polymerization, and bulk polymerization of an aromatic vinyl compound and a vinyl cyanide compound.

The aromatic vinyl compound may be selected from styrene, α-methylstyrene, p-methylstyrene, p-t-butylstyrene, 2,4-dimethylstyrene, chlorostyrene, vinyltoluene, vinylnaphthalene, and a mixture thereof.

The vinyl cyanide compound may be selected from acrylonitrile, methacrylonitrile, fumaronitrile, and a mixture thereof.

The aromatic vinyl-vinyl cyanide copolymer may include a component derived from the aromatic vinyl compound in an amount of, for example greater than or equal to 55 wt%, for example greater than or equal to 60 wt%, or for example greater than or equal to 65 wt%, and for example less than or equal to 80 wt%, for example less than or equal to 75 wt%, for example 55 to 80 wt%, or for example 60 to 75 wt%, based on 100 wt%.

In addition, the aromatic vinyl-vinyl cyanide copolymer may include a component derived from the vinyl cyanide compound in an amount of, for example, greater than or equal to 20 wt%, for example greater than or equal to 25 wt%, and for example less than or equal to 45 wt%, or for example less than or equal to 40 wt%, for example 20 to 45 wt%, or for example 25 to 40 wt%, based on 100 wt%.

In an embodiment, the aromatic vinyl-vinyl cyanide copolymer may be a styrene-acrylonitrile (SAN) copolymer.

In an embodiment, the aromatic vinyl-vinyl cyanide copolymer may be included in an amount of 30 to 75 wt%, for example 40 to 75 wt%, for example 45 to 75 wt%, for example 45 to 70 wt%, or for example 45 to 65 wt%, based on 100 wt% of the base resin.

When the amount of the aromatic vinyl-vinyl cyanide copolymer is less than 30 wt%, moldability of the thermoplastic resin composition may be reduced, and when it exceeds 75 wt%, mechanical properties of the molded article using the thermoplastic resin composition may be reduced.

### (B) Polyamide Resin

In an embodiment, the polyamide resin enables the thermoplastic resin composition to implement excellent electrical conductivity without adding an excessive amount of the polyether ester amide block copolymer.

In an embodiment, the polyamide resin may be various polyamide resins known in the art, and for example, an aromatic polyamide resin, an aliphatic polyamide resin, or a mixture thereof, but the present invention is not particularly limited thereto.

The aromatic polyamide resin is a polyamide including an aromatic group in a main chain, and may be a wholly aromatic polyamide, a semi-aromatic polyamide, or a mixture thereof.

The wholly aromatic polyamide refers to a polymer of an aromatic diamine and an aromatic dicarboxylic acid, and the semi-aromatic polyamide refers to inclusion of at least one aromatic unit and a non-aromatic unit between amide bonds. For example, the semi-aromatic polyamide may be a polymer of an aromatic diamine and an aliphatic dicarboxylic acid, or a polymer of an aliphatic diamine and an aromatic dicarboxylic acid.

Meanwhile, the aliphatic polyamide refers to a polymer of an aliphatic diamine and an aliphatic dicarboxylic acid.

Examples of the aromatic diamine may include, but are not limited to, p-xylenediamine and m-xylenediamine. In addition, these may be used alone or in combination of two or more.

Examples of the aromatic dicarboxylic acid may include phthalic acid, isophthalic acid, terephthalic acid, 2,6-naphthalenedicarboxylic acid, (1,3-phenylenedioxy)diacetic acid, and the like, but are not limited thereto. In addition, these may be used alone or in combination of two or more.

Examples of the aliphatic diamine may include ethylenediamine, trimethylenediamine, hexamethylenediamine, dodecamethylenediamine, piperazine, and the like, but are not limited thereto. In addition, these may be used alone or in combination of two or more.

Examples of the aliphatic dicarboxylic acid may include adipic acid, sebacic acid, succinic acid, glutaric acid, azelaic acid, dodecanedioic acid, dimer acid, cyclohexanedicarboxylic acid, and the like, but are not limited thereto. In addition, these may be used alone or in combination of two or more.

In an embodiment, the polyamide resin may include polyamide 6, polyamide 66, polyamide 46, polyamide 11, polyamide 12, polyamide 610, polyamide 612, polyamide 61, polyamide 6T, polyamide 4T, polyamide 410, polyamide 510, polyamide 1010, polyamide 1012, polyamide 10T, polyamide 1212, polyamide 12T, polyamide MXD6, or a combination thereof.

In an embodiment, the polyamide resin may include at least polyamide 6.

In an embodiment, the polyamide resin may be included in an amount of 5 to 40 wt%, for example 5 to 35 wt%, for example 5 to 30 wt%, for example 5 to 25 wt%, or for example 5 to 20 wt%, based on 100 wt% of the base resin.

When the amount of the polyamide resin satisfies the above range, the thermoplastic resin composition and molded article produced therefrom may exhibit improved rigidity, toughness, abrasion resistance, chemical resistance, and oil resistance due to the polyamide resin.

On the other hand, when the amount of the polyamide resin is less than 5 wt%, improved physical properties due to the polyamide resin may be difficult to obtain, when it exceeds 40 wt%, mechanical strength and/or heat resistance of the thermoplastic resin composition and a molded article using the same may decrease.

### (C) Polyether Ester Amide Block Copolymer

In an embodiment, the polyether ester amide block copolymer may exhibit predetermined electrical conductivity in the thermoplastic resin composition and the molded article produced therefrom.

In addition, the polyether ester amide block copolymer may allow the thermoplastic resin composition and the molded article produced therefrom to exhibit the aforementioned electrical conductivity as well as maintain excellent balance of physical properties.

In an embodiment, the polyether ester amide block copolymer may be, for example, a reaction mixture of an aminocarboxylic acid, lactam, or a diamine-dicarboxylic acid salt having 6 or more carbon atoms; polyalkylene glycol; and a dicarboxylic acid having 4 to 20 carbon atoms.

In an embodiment, the aminocarboxylic acid, lactam, or diamine-dicarboxylic acid salt having 6 or more carbon atoms may be aminocarboxylic acids such as ω-aminocaproic acid, ω-aminoenanthic acid, ω-aminocaprylic acid, ω-aminopel argonic acid, ω-aminocapric acid, 11-aminoundecanoicacid, and 12-aminododecanoic acid; lactams such as ε-caprolactam, enanthlactam, caprylactam, laurolactam and the like; and diamine-dicarboxylic acid salts such as a salt of hexamethylene diamine-adipic acid, a salt of hexamethylene diamineisophthalic acid, and the like. For example, salts of 12-aminododecanoic acid, ε-caprolactam, hexamethylenediamine-adipic acid, and the like may be used.

In an embodiment, the polyalkylene glycol may be polyethylene glycol, polypropylene glycol, polytetramethylene glycol, polyhexamethylene glycol, a block or random copolymer of ethylene glycol and propylene glycol, a copolymer of ethylene glycol and tetrahydrofuran, and the like. For example, polyethylene glycol, a copolymer of ethylene glycol and propylene glycol, etc. may be used.

In an embodiment, examples of the dicarboxylic acid having 4 to 20 carbon atoms may include terephthalic acid, 1,4-cyclohexanedicarboxylic acid, sebacic acid, adipic acid, dodecanedioic acid, and the like.

In an embodiment, a bond between the aminocarboxylic acid, lactam, or diamine-dicarboxylic acid salt having 6 or more carbon atoms and the polyalkylene glycol may be an ester bond, a bond between the aminocarboxylic acid, lactam, or diamine-dicarboxylic acid salt having 6 or more carbon atoms and the dicarboxylic acid having 4 to 20 carbon atoms may be an amide bond, and a bond between the polyalkylene glycol and the dicarboxylic acid having 4 to 20 carbon atoms may be an ester bond.

In an embodiment, the polyether ester amide block copolymer may be prepared by a known synthesis method, for example, a synthesis method disclosed in Japanese Patent Publication Sho 56-045419 and Japanese Patent Laid-Open Publication No. Sho 55-133424.

In an embodiment, the polyether ester amide block copolymer may include 10 to 95 wt% of the polyether ester block. Within the range, the thermoplastic resin composition may exhibit excellent electrical conductivity, heat resistance, and the like.

In an embodiment, the polyether ester amide block copolymer may be included in an amount of 1 to 15 parts by weight, for example 2 to 10 parts by weight, based on 100 parts by weight of the base resin. When the polyether ester amide block copolymer satisfies the aforementioned ranges, the thermoplastic resin composition and the molded article produced therefrom may maintain an excellent balance of physical properties and may simultaneously exhibit excellent electrical conductivity.

### (D) Maleic Anhydride-Aromatic Vinyl-Vinyl Cyanide Copolymer

In an embodiment, the maleic anhydride-aromatic vinyl-vinyl cyanide copolymer may maintain the balance of physical properties of the thermoplastic resin composition and the molded article produced therefrom at an appropriate level. Specifically, the maleic anhydride-aromatic vinyl-vinyl cyanide copolymer may excellently maintain various physical properties (e.g., impact resistance, heat resistance, etc.), which may be deteriorated according to the addition of the polyether ester amide block copolymer.

In an embodiment, the maleic anhydride-aromatic vinyl-vinyl cyanide copolymer may be prepared by using maleic anhydride, an aromatic vinyl compound, and a vinyl cyanide compound in a common polymerization method such as emulsion polymerization, suspension polymerization, solution polymerization, bulk polymerization, and the like.

The aromatic vinyl compound may be selected from styrene, α-methylstyrene, p-methylstyrene, p-t-butylstyrene, 2,4-dimethylstyrene, chlorostyrene, vinyltoluene, vinylnaphthalene, and a mixture thereof, and preferably, styrene.

The vinyl cyanide compound may be selected from acrylonitrile, methacrylonitrile, fumaronitrile, and a mixture thereof, and preferably, acrylonitrile.

The copolymerization of the maleic anhydride-aromatic vinyl-vinyl cyanide copolymer is not particularly limited but may be alternating copolymerization, random copolymerization, or block copolymerization of a component derived from maleic anhydride, a component derived from an aromatic vinyl compound, and a component derived from a vinyl cyanide compound, through which the component derived from maleic anhydride is copolymerized with the component derived from an aromatic vinyl compound and the component derived from a vinyl cyanide compound.

In an embodiment, the maleic anhydride-aromatic vinyl-vinyl cyanide copolymer may be a maleic anhydride-styrene-acrylonitrile copolymer.

The maleic anhydride-aromatic vinyl-vinyl cyanide copolymer may include, based on 100 wt%, 0.5 to 30 wt% of the component derived from maleic anhydride, 50 to 90 wt% of the component derived from an aromatic vinyl compound, and 5 to 40 wt% of the component derived from a vinyl cyanide compound. When the ranges are satisfied, the thermoplastic resin composition and the molded article produced therefrom may exhibit excellent impact resistance and/or heat resistance.

In an embodiment, the maleic anhydride-aromatic vinyl-vinyl cyanide copolymer may be included in an amount of 0.5 to 10 parts by weight, for example 0.5 to 9 parts by weight, for example 0.5 to 8 parts by weight, for example 1 to 8 parts by weight, for example 1 to 7 parts by weight, for example 1 to 6 parts by weight, or for example 1 to 5 parts by weight, based on 100 parts by weight of a base resin.

When the content of the maleic anhydride-aromatic vinyl-vinyl cyanide copolymer satisfies the above ranges, the thermoplastic resin composition and the molded article produced therefrom may not only maintain an excellent balance of physical properties but also may simultaneously exhibit excellent electrical conductivity.

### (E) Other Additives

In addition to the components (A) to (D), the thermoplastic resin composition according to an embodiment may further include one or more additives in order to balance each property under the condition that both excellent electrical conductivity and a balance of physical properties are maintained, or depending on the end use of the thermoplastic resin composition.

Specifically, the additive may be a nucleating agent, a coupling agent, a filler, a plasticizer, a lubricant, a mold release agent, an antibacterial agent, a heat stabilizer, an antioxidant, a UV stabilizer, a flame retardant, a colorant, an impact modifier, etc., and these may be used alone or in combination of two or more.

The additive may be appropriately included within a range that does not impair the physical properties of the thermoplastic resin composition, and specifically, may be included in an amount of less than or equal to 20 parts by weight based on 100 parts by weight of a base resin, but is not limited thereto.

The thermoplastic resin composition according to the present invention may be prepared by a known method for preparing a thermoplastic resin composition.

For example, the thermoplastic resin composition according to the present invention may be prepared in the form of pellets by simultaneously mixing the constituents of the present invention and other additives and then meltkneading the mixture in an extruder.

A molded article according to an embodiment of the present invention may be produced from the aforementioned thermoplastic resin composition.

In an embodiment, the molded article may have a notched Izod impact strength of a ¼″-thick specimen according to ASTM D256 ranging from 20 to 60 kgf·cm/cm, for example 20 to 50 kgf·cm/cm, for example 20 to 40 kgf·cm/cm, or for example 20 to 35 kgf·cm/cm.

In an embodiment, the molded article has surface resistance measured on a 100 mm x 100 mm x 20 mm specimen using a surface resistance measuring device (manufacturer: SIMCO-ION, model name: Worksurface Tester ST-4) of less than or equal to 10¹² Ω/sq, for example less than or equal to 10^{11.9} Ω/sq, for example less than or equal to 10^{11.8} Ω/sq, for example less than or equal to 10^{11.7} Ω/sq, or for example less than or equal to 10^{11.6} Ω/sq.

In an embodiment, the molded article may have a heat deflection temperature (HDT) according to ASTM D648 of 80 to 100° C., for example 80 to 95° C., or for example 80 to 90° C.

As such, since the thermoplastic resin composition has excellent impact resistance, electrical conductivity, and heat resistance, it may be widely applied to various products used for painting and non-painting, and in particular, may also be usefully applied to molded articles for painting requiring electrostatic painting.

Hereinafter, the present invention is illustrated in more detail with reference to examples and comparative examples. However, the following examples and comparative examples are provided for the purpose of descriptions and the present invention is not limited thereto.

### Examples 1 to 4 and Comparative Examples 1 to 7

The thermoplastic resin compositions according to Examples 1 to 4 and Comparative Examples 1 to 7 were prepared according to each component content ratio shown in Table 1.

In Table 1, (A1), (A2), and (B) included in a base resin are expressed by wt% based on the total weight of the base resin, and (C) and (D) also included in the base resin are expressed by parts by weight based on 100 parts by weight of the base resin.

The components shown in Table 1 were dry-mixed, and then quantitatively and continuously fed into a hopper of a twin-screw extruder (L/D = 44, diameter = 45 mm) and melted/kneaded. Then, the thermoplastic resin compositions pelletized through a twin-screw extruder were dried at about 80° C. for about 4 hours, and then specimens for physical property evaluation were prepared using a 120-ton injection molding machine with a cylinder temperature of about 240° C. and a mold temperature of about 60° C.

TABLE 1

| | | Ex. 1 | Ex. 2 | Ex. 3 | Ex. 4 | Comp. Ex. 1 | Comp. Ex. 2 | Comp. Ex. 3 | Comp. Ex. 4 | Comp. Ex. 5 | Comp. Ex. 6 | Comp. Ex. 7 |
|---|---|---|---|---|---|---|---|---|---|---|---|---|
| Base resin | (A1) | 32 | 32 | 32 | 32 | 32 | 32 | 32 | 32 | 32 | 32 | 32 |
| | (A2) | 58 | 58 | 53 | 53 | 58 | 58 | 53 | 53 | 68 | 58 | 58 |
| | (B) | 10 | 10 | 15 | 15 | 10 | 10 | 15 | 15 | 0 | 10 | 10 |
| (C) | | 6 | 6 | 6 | 6 | 6 | 0 | 6 | 0 | 6 | 0 | 20 |
| (D) | | 2 | 4 | 2 | 4 | 0 | 2 | 0 | 2 | 2 | 0 | 2 |

Each component provided in Table 1 is illustrated as follows.

### (A1) Butadiene-Based Rubber-Modified Aromatic Vinyl-Vinyl Cyanide Graft Copolymer

Acrylonitrile-butadiene-styrene graft copolymer (Lotte Chemical Corp.) including about 58 wt% of a core (average particle diameter: about 0.25 µm) made of a butadiene rubbery polymer and a shell formed by graft-polymerization of acrylonitrile and styrene (in a weight ratio of acrylonitrile : styrene = about 2.5 : about 7.5) on the core

### (A2) Aromatic Vinyl-Vinyl Cyanide Copolymer

Styrene-acrylonitrile copolymer (Lotte Chemical Corp.) copolymerized from a monomer mixture of about 28 wt% of acrylonitrile and about 72 wt% of styrene and having a weight average molecular weight of about 110,000 g/mol

### (B) Polyamide Resin

Polyamide 6 resin (EN-300, KP Chemtech) having a melting point of about 223° C. and relative viscosity of about 2.3

### (C) Polyether Ester Amide Block Copolymer

Polyamide 6-polyethylene oxide block copolymer (PA6-b-PEO) (PELECTRON AS, Sanyo Chemical, Ltd.)

### (D) Maleic Anhydride-Aromatic Vinyl-Vinyl Cyanide Copolymer

Maleic anhydride-styrene-acrylonitrile copolymer (SAM-010, Sunny FC)

### EXPERIMENTAL EXAMPLES

Experiment results are provided in Table 2.
(1) Surface resistance (unit: Q/sq): A specimen with a size of 100 mm x 100 mm x 20 mm was measured with respect to surface resistance by using a surface resistance measuring device (model name: Worksurface Tester ST-4, manufacturer: SIMCO-ION).
(2) Heat resistance (unit: °C): A heat deflection temperature (HDT) was measured according to ASTM D648.
(3) Impact resistance Type-I (unit: kgf·cm/cm): A specimen with a thickness of ¼”was measured with respect to notched Izod impact strength according to ASTM D256.
(4) Impact resistance Type-ll (unit: N): A specimen having a boss shape (protruding portion external diameter: 6 mm, protruding portion internal diameter: 3.5 mm, protruding portion height: 20 mm) was measured with respect to boss Impact strength according to the following experiment method. Specifically, an impact hammer of about 420 g was used to apply an impact to a side of the specimen, which had a boss shape, wherein the impact was set at energy of 1.8J.

Table 2

| | | Ex. 1 | Ex. 2 | Ex. 3 | Ex. 4 | Comp. Ex. 1 | Comp. Ex. 2 | Comp. Ex. 3 | Comp. Ex. 4 | Comp. Ex. 5 | Comp. Ex. 6 | Comp. Ex. 7 |
|---|---|---|---|---|---|---|---|---|---|---|---|---|
| Surface resistance | | 10^{11.4} | 10^{11.6} | 10^{10.9} | 10^{10.8} | 10^{10.9} | greater than 10^{13.5} | 10^{10.2} | greater than 10^{13.5} | greater than 10^{13.5} | greater than 10^{13.5} | 10^{9.1} |
| Heat deflection temperature | | 83 | 83 | 82 | 82 | 82 | 85 | 83 | 83 | 83 | 83 | 79 |
| Impact resistance | Type-l (Izod) | 29 | 31 | 27 | 34 | 18 | 11 | 16 | 10 | 35 | 8 | 42 |
| | Type-ll (boss) | 120 | 125 | 118 | 128 | 98 | 89 | 95 | 85 | 128 | 85 | 135 |

Referring to Tables 1 and 2, Examples 1 to 4 used the butadiene-based rubber-modified aromatic vinyl-vinyl cyanide graft copolymer, the aromatic vinyl-vinyl cyanide copolymer, the polyamide resin, the polyether ester amide block copolymer, and the maleic anhydride-aromatic vinyl-vinyl cyanide copolymer in optimal amounts, providing a thermoplastic resin composition and a molded article using the same showing excellent electrical conductivity, impact resistance, and heat resistance, compared with the comparative examples.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. A thermoplastic resin composition, comprising:
based on 100 parts by weight of a base resin including (A1) 20 to 40 wt% of a butadiene-based rubber-modified aromatic vinyl-vinyl cyanide graft copolymer;
(A2) 30 to 75 wt% of an aromatic vinyl-vinyl cyanide copolymer; and
(B) 5 to 40 wt% of a polyamide resin;
(C) 1 to 15 parts by weight of a polyether ester amide block copolymer; and
(D) 0.5 to 10 parts by weight of a maleic anhydride-aromatic vinyl-vinyl cyanide copolymer.

2. The thermoplastic resin composition of claim 1, wherein
the (A1) butadiene-based rubber-modified aromatic vinyl-vinyl cyanide graft copolymer has a core-shell structure including
a core of a butadiene-based rubbery polymer, and
a shell formed by graft polymerization of an aromatic vinyl compound and a vinyl cyanide compound.

3. The thermoplastic resin composition of claim 2, wherein
in the (A1) butadiene-based rubber-modified aromatic vinyl-vinyl cyanide graft copolymer, an average particle diameter of the butadiene-based rubbery polymer is 0.2 to 1.0 µm.

4. The thermoplastic resin composition of claim 1, wherein
the (A1) butadiene-based rubber-modified aromatic vinyl-vinyl cyanide graft copolymer is an acrylonitrile-butadiene-styrene copolymer.

5. The thermoplastic resin composition of claim 1, wherein
the (A2) aromatic vinyl-vinyl cyanide copolymer includes 55 to 80 wt% of a component derived from an aromatic vinyl compound and 20 to 45 wt% of a component derived from a vinyl cyanide compound based on 100 wt%.

6. The thermoplastic resin composition of claim 1, wherein
the (A2) aromatic vinyl-vinyl cyanide copolymer has a weight average molecular weight of 80,000 to 300,000 g/mol.

7. The thermoplastic resin composition of claim 1, wherein
the (A2) aromatic vinyl-vinyl cyanide copolymer is a styrene-acrylonitrile copolymer.

8. The thermoplastic resin composition of claim 1, wherein
the (B) polyamide resin includes polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

9. The thermoplastic resin composition of claim 1, wherein
the (C) polyether ester amide block copolymer is a reaction mixture of an aminocarboxylic acid, lactam, or a diamine-dicarboxylic acid salt having 6 or more carbon atoms; polyalkylene glycol; and a dicarboxylic acid having 4 to 20 carbon atoms.

10. The thermoplastic resin composition of claim 1, wherein
the (D) maleic anhydride-aromatic vinyl-vinyl cyanide copolymer is a maleic anhydride-styrene-acrylonitrile copolymer.

11. The thermoplastic resin composition of claim 1, wherein
the thermoplastic resin composition further includes at least one additive selected from a nucleating agent, a coupling agent, a filler, a plasticizer, a lubricant, a mold release agent, an antibacterial agent, a heat stabilizer, an antioxidant, an ultraviolet stabilizer, a flame retardant, a colorant, and an impact modifier.

12. A molded article produced from the thermoplastic resin composition of claim 1.

13. The molded article of claim 12, wherein
the molded article has a notched Izod impact strength of a ¼″-thick specimen according to ASTM D256 ranging from 20 to 60 kgf·cm/cm.

14. The molded article of claim 12, wherein
the molded article has surface resistance of less than or equal to 10^{12.0} Ω/sq measured for a 100 mm x 100 mm x 20 mm specimen using a surface resistance measuring device (manufacturer: SIMCO-ION, model name: Worksurface Tester ST-4).

15. The molded article of claim 12, wherein
the molded article has a heat deflection temperature (HDT) of 80 to 100° C. according to ASTM D648.
